(19) United States
(12) Patent Application Publication
(10) Pub. No.: US 2005/0213249 A1
(43) Pub. Date: Sep. 29, 2005

(54) Portable information terminal

(76) Inventor: Kazuhito Shimomura, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/048,547

(22) Filed: Feb. 1, 2005

(30) Foreign Application Priority Data
Mar. 26, 2004 (JP) 2004-092863

(51) Int. Cl. G11B 23/03

(52) U.S. Cl. 360/137

(57) ABSTRACT

A portable information terminal has a main body portion and a cover portion. A main body portion has a key switches and a microphone. A cover portion has an open state and a close state. The key switches enable to be operated in the open state. A hard disc drive (HDD) as magnetic disc device has a heat generating board and is disposed in the main body portion so that the heat generating board faces a side of the front surface. A sound insulator is disposed in the main body portion so that the sound insulator insulates sound of the HDD from the microphone.

### CROSS-REFERENCE TO RELATED APPLICATIONS

This application is based upon and claims the benefit of priority from the prior Japanese Patent Application No. 2004-092863, filed on Mar. 26, 2004; the entire contents of which are incorporated herein by reference.

### BACKGROUND

1. Field

Embodiments of the present invention relate to a portable information terminal provided with a magnetic disc device.

2. Description of the Related Art

In recent years, cellular phones have made remarkable improvements in their communication speed due to improvements in hardware function of its terminal and to the establishment of high-speed communication infrastructures. Under such conditions, the cellular phone is intended to be used in applications other than telephone and mailing, for example, in downloading images and sounds for viewing and listening, and the like.

In order to enable to view images and listen to sounds, a cellular phone has to be provided with a mass storage unit. Different types of mass storage units, such as a large-capacity flash memory or a magnetic disc device have been implemented into cellular phones. However, magnetic disc device currently surpasses a large capacity flash memory in terms of storage capacity and price. Therefore, it is practical to mount the magnetic disc device in the cellular phone, provided a few potential disadvantages can be avoided.

First, magnetic disc devices need to be lessened in weight, thickness, and size than their currently 2.5 inches or 1 inch sizes when they are to be mounted in cellular phones. However, such reductions will inevitably result in reliability problems. For example, a cellular phone with a fragile casing exposes the magnetic disc device to pressure forces caused by key operation and to heat generated from a display that is becoming larger in screen size.

Meanwhile, a magnetic disc device reads/writes information from/to a magnetic disc by a magnetic head provided close to the magnetic disc rotating at high speed. Therefore, the magnetic disc device may be the cause of noise at the time of a call.

As described above, roughly two problems, namely the noise problem at the time of a call and the problem of susceptibility to pressure and heat are highlighted in mounting a magnetic disc device in a cellular phone.

As such an applied apparatus, for example, Japanese Patent Laid-Open Application No. 2003-179687 discloses a cellular phone, provided with the magnetic disc, in which the operation of a magnetic disc device and communication are exclusively performed to realize reduction in power consumption.

In this prior art, the magnetic disc device is electrically controlled to stop its operation during a call which can be considered as part of communication, thereby realizing power saving. Accordingly, this prior art can provide a by product effect of eliminating noises of the magnetic disk device audible to a user.

However, according to the above mentioned cellular phone, since the magnetic disc device does not operate during a call, responsiveness is lowered at its return from the nonoperation state, and the magnetic disc device is stopped if an unexpected call occurs during its operation, which will be problematic inview of the intended use of the magnetic disc device as a data storage device.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention in which:

FIG. 1A is a perspective view of a cellular phone according to a first embodiment of the present invention in an open state.

FIG. 1B is a perspective view of the cellular phone according to the first embodiment of the present invention in a course of being closed.

FIG. 2 is a block diagram showing an exemplary configuration of a control system inside the cellular phone shown in FIG. 1.

FIG. 3 is a cross-sectional view showing an internal structure of a HDD mounted in the cellular phone shown in FIG. 1.

FIG. 4 is a cross-sectional view showing an exemplary internal structure of the cellular phone shown in FIG. 1.

FIG. 5 is a perspective view of a cellular phone according to a second embodiment of the present invention.

FIG. 6 is a perspective view of a cellular phone according to a third embodiment of the present invention.

FIG. 7 is a perspective view of a cellular phone according to a fourth embodiment of the present invention.

### DETAILED DESCRIPTION

Embodiments of the present invention will be described in detail with reference to the accompanying drawings.

### I. First Embodiment

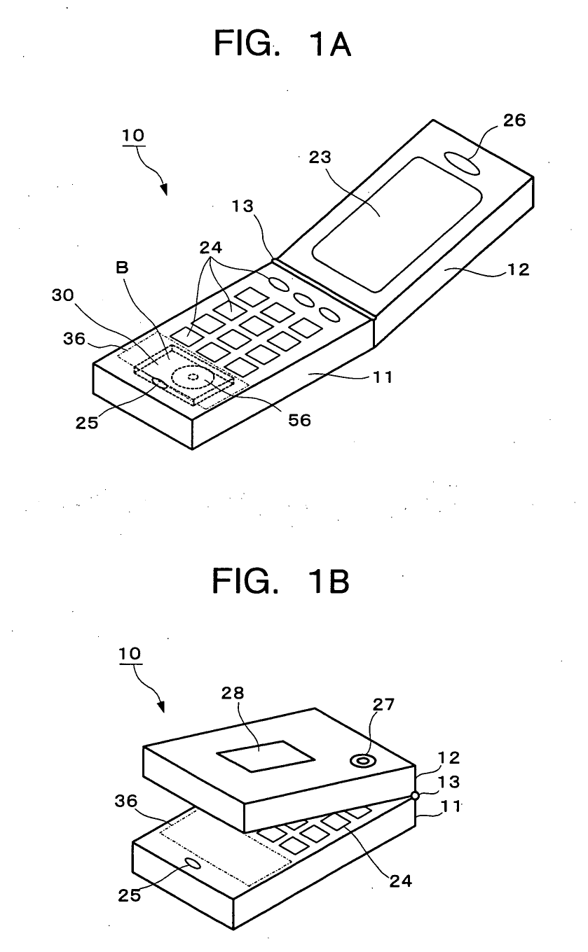

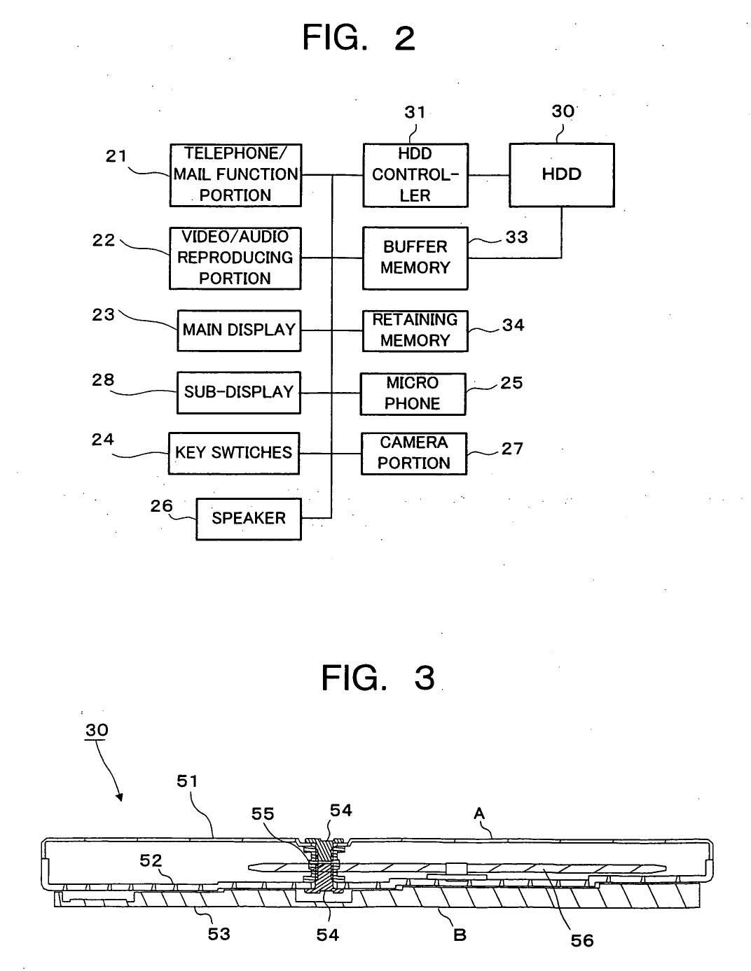

FIG. 1A and FIG. 1B are perspective views of a folding-type cellular phone 10 according to a first embodiment of the portable information terminal. FIG. 1A shows an open state of the cellular phone 10, and FIG. 1B shows a state in the course of being closed of the cellular phone 10. FIG. 2 is a block diagram showing the configuration of a control system of the cellular phone 10.

As shown in FIG. 1A and FIG. 1B, the cellular phone 10 is divided into two casings, the main body portion 11 and a cover portion 12. Incidentally, these casings may be called a casing for key switch placement block and a casing for display block, respectively.

These main body portion 11 and cover portion 12 are openably/closably connected with each other by a hinge portion 13. As a result, the cellular phone 10 takes three states: (1) a state in which the cover portion 12 is opened (open state: FIG. 1A); (2) a state in which the cover portion 12 is in the course of being closed (closing state: FIG. 1B); and (3) a closed state in which the cover portion 12 is closed (not shown). The open state and the closing state are maintained by a ratchet mechanism (not shown) provided in the hinge portion 13.

Incidentally, the cellular phone 10 in this example is structured such that the main body portion 11 and the cover portion 12 are turnably supported by the hinge portion 13 to open/close like a shell. However, some cellular phone is structured such that the cover portion 12 is slidable relative to the main body portion 11 or the cover portion 12 is turnable in the right and left direction with respect to a fulcrum provided in the main body portion 11. The present invention is also applicable to such cellular phones.

As shown in FIG. 1A, FIG. 1B, and FIG. 2, the cellular phone 10 comprises a telephone/mail function portion 21, a video/audio reproducing portion 22, display portions such as a main display 23 and a sub-display 28, key switches 24 as a key operation portion, a microphone 25 as an audio input portion, a speaker 26 as an audio output portion, a camera portion 27, a hard disc drive controller 31 (hereinafter, referred to as a “HDD controller” 31), a hard disc drive 30 (hereinafter referred to as a “HDD” 30) as a magnetic disc device, a buffer memory 33, and a retaining memory 34.

The telephone/mail function portion 21 enables exchange of calls and messages (e.g., emails and instant messages) between the cellular phone 10 and other telephones and it includes a not-shown antenna.

The video/audio reproducing portion 22 enables to view and listen to video and audio contents stored in the HDD 30 through the display portions and the audio output portion 26.

The display portions such as the main display 23 and the sub-display 28 are composed of liquid crystal displays, EL displays, or the like. The display portions are among components preferably disposed apart from the HDD 30 since they generate heat when in use. The main display 23 is provided on a surface (display surface) of the cover portion 12 facing a front surface of the main body portion 11.

The sub-display 28 is disposed in a substantially center part of a surface (hereinafter referred to as a “rear surface”)) of the cover portion 12 opposite a surface (display surface) where the main display 23 is provided. The sub-display 28 serves as an auxiliary display portion when the main display 23 is closed. For example, when the size of the main display 23 is about 2×1.5 inches, the size of the sub-display 28 is about 1×0.7 inches.

The key switches 24 is generally an information input interface such as a keypad, which may include but is not limited or restricted to ten-keys (0-9), a power button, a call button, and a mail button. The key switches 24 are provided in the main body portion 11, being placed on the front surface (also referred to as “operation surface”) that faces the cover portion 12 when the cover portion 12 is closed. The key switches 24 are pressed by a user, that is, a pressing force is given thereto, and portions under the key switches 24 may receive loads directly.

The microphone 25 is an audio input device such as a capacitor microphone. The microphone 25 is a device collecting sounds and is one of components desirably disposed apart from the HDD 30, which is a noise generating source.

The speaker 26 is an audio output device that outputs the other party's voice during a call and generates various kinds of sounds such as a mail reception sound. The speaker 26 is provided with a magnet. Further, the speaker 26 is placed in close proximity to a user's ear for audio reception, and thus is one of the components desirably disposed apart from the HDD 30 which is a noise generating source.

The camera portion 27 is disposed on the rear surface of the cover portion 12, being positioned closer to the hinge portion 13 than a top edge of cover portion 12. The camera portion 27 is adapted to capture still and moving images. The image data captured by the camera portion 27 is stored in retaining memory 34 or the HDD 30.

In addition, external output terminals (an earphone jack and an external speaker terminal) outputting audio signals may be provided. A user can appropriately select a speaker, an earphone, an external speaker, or the like as an audio output destination.

The buffer memory 33 is a memory for exchanging data with the HDD 30. The retaining memory 34 is a memory for retaining information necessary for the telephone/mail function portion 21, the video/audio reproducing portion 22, and so on. A flash memory or the like is used as the retaining memory 34. The HDD controller 31 controls the read and write of information from/to the HDD 30.

The HDD 30 is disposed in the main body portion 11, being positioned below a finger rest area 36. The finger rest area 36 is provided on a first area of the main body portion 11, which does not include an area of the front surface where the key switches 24 and the microphone 25 are provided. The HDD 30 is disposed in the main body portion 11 so that a surface B of PCB 53 (described below) thereof, which is a heat generating surface, faces the operation (front) surface side of the main body portion 11. In other words, surface B of PCB 53 is positioned closer to the front surface of the main body portion 11, which includes key switches 24, than a back surface side of the main body portion 11.

FIG. 3 is a cross-sectional view showing an internal structure of a HDD 30 mounted in the cellular phone 10. As shown in FIG. 3, the HDD 30 includes a top cover 51 and a base 52 (collectively referred to as the “housing”), a printed circuit board 53 (hereinafter, referred to as a “PCB” 53), a fastening element (e.g., screw, rivet, bolt, etc.) 54, a column 55, a magnetic disc 56 (hereinafter, referred to as a “HD” 56), and so on.

The top cover 51 is an upper cover made of a thin plate of rigid material, such as a metal like stainless steel for example, and it is part of a case of the HDD 30. The base 52 is a bottom cover covered by the top cover 51, and the base 52 and the top cover 51 constitute a case structure.

The PCB 53 has wiring formed on an insulated substrate by using a printing technique, and is formed in such a manner that (unnecessary) portions other than the wiring in a copper thin film on the substrate are dissolved by etching. Circuit components are mounted thereon. During operation, this PCB 53 portion generates heat.

The fastening element 54 fixes the top cover 51 to the column 55. The column 55 is a pillar member for securing a constant height of space between the top cover 51 and the base 52. The space allows the HD 56 to rotate therein.

The HD 56 is fixed to the base 52 to be rotatable by a motor (not shown). A magnetic head (not shown) writes and read information to/from the HD 56.

A surface of the HDD 30 on the top cover 51 side will be called a cover surface A and a surface thereof on the PCB 53 side will be called a PCB surface B. The cover surface A is a surface relatively weak to pressure from the above. The PCB surface B is a surface generating heat (heat generating surface).

The HDD 30 is a magnetic disc device for storing various content (e.g., images, audio, movies, programs, video games, etc.). The HDD 30 has the HD 56, the motor, and the magnetic head, and it reads and writes information to/from the HD 56 by the magnetic head and the motor.

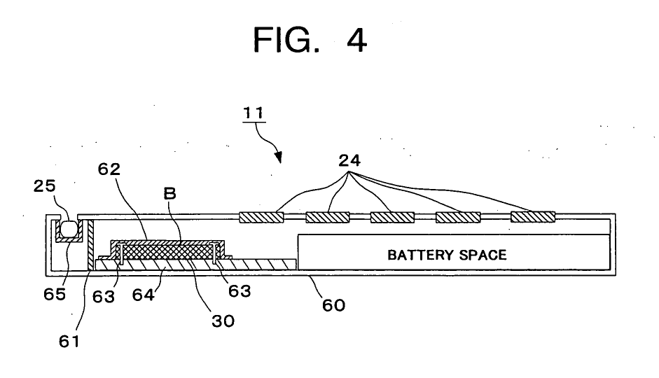

FIG. 4 is a cross-sectional view showing an internal structure of the main body portion 11 of the cellular phone 10. As shown in FIG. 4, the main body portion 11 includes the key switches 24, the microphone 25, the HDD 30, a sound insulating wall 61, a sound insulating sheet 62, fastening elements 63, a base portion 64, and a sound insulating sheet 65 which are housed in a casing 60.

A battery space is provided in the casing 60. The battery space occupies a large area and the base portion 64 is fixed in a vacant space excluding the battery space. The base portion 64 is fixed to a bottom of the casing 60. The HDD 30 is fixed to the base portion 64 with the fastening elements 63.

As for the arrangement direction of the surface of the HDD 30, the PCB surface B is set on an upper side, i.e., the PCB surface B faces the operation (front) surface side of the main body portion 11. According to this embodiment, the PCB surface B is set on the upper side to counter any pressure from the operation surface.

As for the longitudinal/lateral placement direction of the HDD 30, the HDD 30 is disposed so that the longitudinal direction thereof is perpendicular to the longitudinal direction of the main body portion 11. This arrangement increases the strength against torsion of the main body portion 11.

The sound insulating sheet 62 is pasted up to the base portion 64 to cover the HDD 30 at least partly. A sheet of material with a sound insulating effect is used as the sound insulating sheet 62. Alternatively, a shock absorbing sheet in gel form may be used instead. In this case, it may possess both a sound-absorbing effect and a shock-absorbing effect.

The sound insulating wall 61 is disposed in the casing 60 of the main body portion 11 to separate a space housing the HDD 30 from a space housing the microphone 25. The fastening elements 63 fix the HDD 30 to the base portion 64. The sound insulating sheet 62 is pasted over the fastening elements 63 to cover the HDD 30, thereby shielding noises generated from the HDD 30.

Incidentally, the sound insulating sheet 62 may be disposed to intensively protect a partial area, which possibly becomes a noise source, of the HDD 30. For example, the sound insulating sheet 62 may be disposed inside the HDD 30 so as to intensively cover only a portion having a latch mechanism that holds the motor, which drives the HD 56, and the magnetic head so as to keep them unmoved even with vibration.

In the cellular phone 10, the telephone/mail function portion 21 enables call and mail, and in addition, the video/audio reproducing portion 22 enables viewing images and listening to sounds (for example, music and movies).

The main body portion 11 and the cover portion 12 are opened when the telephone or mail function of the cellular phone 10 is to be used, or when images are to be viewed. At this time, the cellular phone 10 is brought into the open state.

Further, when the cellular phone 10 is not in use, the main body portion 11 and the cover portion 12 are closed. At this time, the cellular phone 10 is brought into the closed state. Audio (e.g., music, ring tones and the like) is audible both in the open state and the closed'state.

Hereinafter, various measures (measures against noises, external pressure, heat, and so on) in the cellular phone 10 of the first embodiment will be described.

A. Measures Against Noises

In the cellular phone 10 of the first embodiment, in the arrangement such that the HDD 30 is disposed in the casing 60, the microphone 25 may possibly collect noises of the HDD 30 depending on the magnitude of the noises of the HDD 30 and on the sound collecting capability (directivity and the like) of the microphone 25.

Therefore, as a noise countermeasure, in the first embodiment, the HDD 30 is disposed in the main body portion 11 side, being positioned as distant as possible from the speaker 26 during a call. In addition, the HDD 30 is covered with the sound insulating sheet 62 with a sound insulating effect, and the sound insulating wall 61 is interposed between the HDD 30 and the microphone 25.

It is most effective that the space housing the microphone 25 and the space housing the HDD 30 are completely separated by the sound insulating wall 61 as shown in FIG. 4. As a modification example, the sound insulating wall 61 may be formed and arranged to match the shape of the microphone 25. That is, the structure acoustically separating the microphone 25 and the HDD 30 prevents the microphone 25 from picking up the noises leaking from the HDD 30.

The low-noise arrangement structure in which the placement spaces of the microphone 25 and the HDD 30 are separated by the sound insulating wall 61 may be utilized along with the sound insulating sheets 62, 65, so that the low-noise arrangement structure of the HDD 30 can be further strengthened.

In this manner, the caller is not disturbed by noises caused by the HDD 30. Moreover, the microphone 25 does not pick up the noises of the HDD 30, which can realize an effective noise reduction.

B. Measures against External Pressure and Shock

In the cellular phone 10 of the first embodiment, the HDD 30 is disposed in the casing 60 below the finger rest area 36 of the operation (front) surface of the main body portion 11. The finger rest area 36 excludes an area of the front surface where the key switches 24 and the microphone 25 are provided. This prevents the HDD 30 from being pressed due to a dent of the casing 60 caused by the pressing force even when any one of the key switches 24 is pressed.

Further, the PCB surface B of the HDD 30 itself faces the operation (front) surface side, so that the HD 56, the magnetic head, and the like do not suffer an adverse effect and the like due to partial distortion of the top cover 51.

Further, the first embodiment has a fundamental feature that the HDD 30 is disposed in the main body portion 11 side that is necessarily held by a caller's hand. This arrangement can additionally provide an effect of greatly lowering the frequency at which the HDD 30 is damaged due to a rotational shock, compared with the arrangement in which the HDD 30 is disposed in the cover portion 12 side.

C. Measures Against Heat

Out of the main body portion 11 and the cover portion 11, the HDD 30 is not disposed in the cover portion 12 having the main display 23 which is a heat source, but in the main body portion 11. This prevents the HDD 30 from being influenced by heat generated from the main display 23.

As described above, according to the cellular phone 10 of the first embodiment, the HDD 30 is disposed at the most appropriate position in the folding-type cellular phone 10 in which the main body portion 11 and the cover portion 12 are turnably supported by the hinge portion 13, so that it is possible to mount a light-weighted and thin HDD 30 in the cellular phone 10 while solving the problems of the external pressure influence, heat, and so on.

Moreover, the HDD 30 and the microphone 25 which are fixed in the casing 60 are covered with the sound insulating sheets 62, 65, so that leakage of the noises generated from the HDD 30 to the outside of the casing 60 and to the microphone 25 is prevented as much as possible, which can realize noise reduction.

Further, in the folding-type cellular phone 10, also obtainable is an effect that the HDD 30 is unsusceptible to a rotational shock and the like caused by the opening/closing of the cellular phone 10.

As a result, the operation of the HDD 30 is not obstructed, the power-consuming HDD 30 can be mounted, and a user hardly hear the noises generated from the HDD 30 even when the HDD 30 is constantly in the operation state.

### II. Second Embodiment

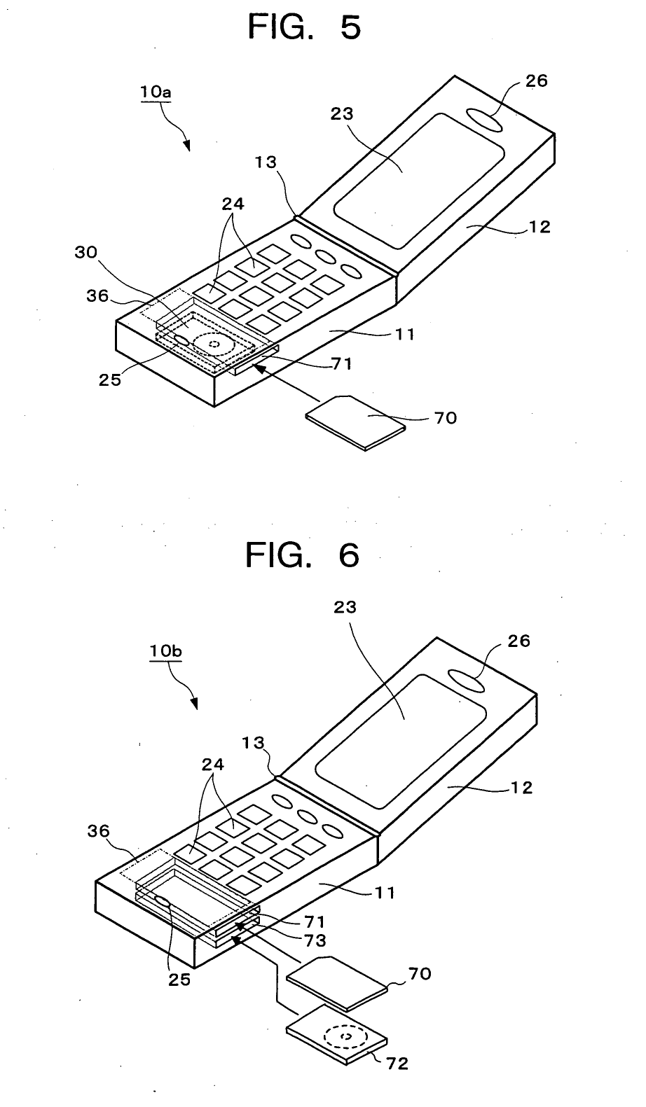

A cellular phone 10a of a second embodiment according to the present invention will be described with reference to FIG. 5. FIG. 5 is a perspective view of the cellular phone 10a. The second embodiment has additional structure added a memory card slot to the structure of the first embodiment. The same reference numerals and symbols are used to designate the same components as those in the above-described first embodiment, and description thereof will not be given.

As shown in FIG. 5, the cellular phone 10a of the second embodiment includes a card slot 71 provided between a finger rest area 36 and a HDD 30 in the main body portion 11, the finger rest area 36 being a first area of an operation (front) surface of a main body portion 11.

A memory card 70, for example, a SD™ card or the like can be inserted into/pulled out of the card slot 71 from a side face of the main body portion 11.

The SD™ card and the HDD 30 are substantially the same in width and length but slightly different in thickness. Specifically, the thickness of the SD™ card is about 2.1 millimeters (mm) while the thickness of HDD 30 is about 3.3 mm, and thus the HDD 30 is slightly thicker.

The card slot 71 is thus disposed above the HDD 30, which further mitigates the transfer of the pressing force caused by the key operation to the HDD 30. Incidentally, as for the arrangement direction of a surface of the HDD 30, setting a PCB surface B oh an upper side as in the first embodiment is one alternative so that the pressing force from the operation (front) surface does not easily affect the HDD 30. In this case, the PCB surface B of the HDD 30 faces the card slot 71.

Therefore, in the arrangement such that the PCB surface B of the HDD 30 faces the card slot 71, it is contemplated that such arrangement may be conducted to inhibit heat transfer between the card slot 71 and a slot of the HDD 30. Specifically, it is possible to interpose a heat transfer buffer member such as a heat insulator therebetween or to adopt a structure allowing easy heat release.

If such structures cannot be adopted, it is effective that the PCB surface B of the HDD 30 is set as distant as possible from the card slot 71, i.e., the PCB surface B is set on a bottom side, thereby realizing the arrangement that mitigates the transfer of the heat from a PCB of the HDD 30 to the SD™ card placed in the card slot 71.

This structure also fully exhibits an effect of inhibiting the transfer of the pressing force caused by the key operation to the HDD 30 since the card slot 71 is disposed above the HDD 30. Further, as for the longitudinal/lateral placement direction of the HDD 30, it is also in accordance with one embodiment to set the longitudinal direction of the HDD 30 perpendicular to the longitudinal direction of the main body portion 11 as in the first embodiment.

### III. Third Embodiment

A cellular phone 10b of a third embodiment according to the present invention will be described with reference to FIG. 6. FIG. 6 is a perspective view of the cellular phone 10b. The same reference numerals and symbols are used to designate the same components as those in the above-described first and second embodiments, and description thereof will not be given.

As shown in FIG. 6, the cellular phone 10b of the third embodiment is a modification example of the second embodiment described above with respect to the structure of HDD 30, which is an external card type.

Two tiers of a card slot 71 and a hard disc slot 72, namely, multiple tiers of slots, are disposed in a main body portion 11, being positioned below a finger rest area 36 which is a first area of an operation surface of the main body portion 11. The card slot 71 is the same as that of the second embodiment.

A HDD of an external card type (referred to as a hard disc card 72, here) that is made by covering the PCB 53 (see FIG. 3) of the HDD 30 of the aforesaid first embodiment with a bottom cover (not shown) can be inserted into/pulled out of the hard disc slot 73 from a side face of the main body portion 11. That is, the hard disc slot 72 is a slot allowing the HDD 30 to be attached/removed without opening a casing 60 by, for example, removing the main body portion 11.

The structure of the third embodiment in which HDD 30 is an external card type can realize an effective noise reduction because user can inserts/pull out HDD 30 into/from the hard disc slot 73 according to user's need.

Such arrangement in which the card slot 71 and the hard disc slot 73 are overlapped in the main body portion 11 makes the hard disc card 72 unsusceptible to the pressing force caused by the key operation. Incidentally, as for the arrangement direction of a surface of the hard disc card 72 placed in the hard disc slot 73, it is one alternative to set the PCB surface B on an upper side as in the first embodiment. In this case, the PCB surface B of the HDD 30 faces the card slot 71.

Therefore, in the arrangement such that the PCB surface B of the HDD 30 faces the card slot 71, it is contemplated that such arrangement would inhibit heat transfer between the card slot 71 and the slot of the HDD 30. Specifically, it is in accordance with one embodiment of the invention to interpose a heat transfer buffer member such as a heat insulator therebetween or to adopt a structure allowing easy heat release.

If such structures cannot be adopted, it is effective that the PCB surface B of the HDD 30 is set as distant as possible from the card slot 71, namely, the PCB surface B is set on a bottom side, thereby realizing the arrangement that mitigates the transfer of the heat from a PCB of the HDD 30 to the SD™ card placed in the card slot 71. This arrangement also fully exhibits an effect of inhibiting the transfer of the pressing force caused by the key operation to the HDD 30 since the card slot 71 is disposed above the HDD 30.

Further, as for the longitudinal/lateral placement direction of the HDD 30, it is also contemplated that the longitudinal direction of the hard disc card 72 may be set perpendicular to the longitudinal direction of the main body portion 11 as in the first embodiment.

### IV. Fourth Embodiment

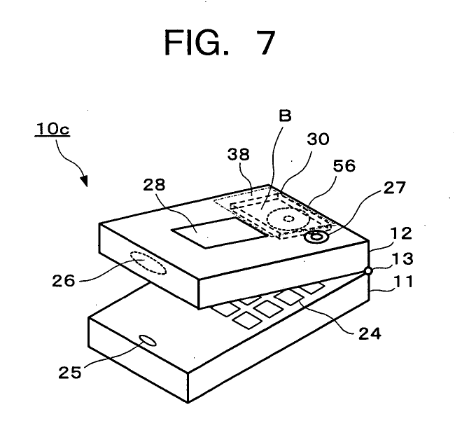

A cellular phone 10c of a fourth embodiment according to the present invention will be described with reference to FIG. 7. FIG. 7 is a perspective view of the cellular phone 10c. The same reference numerals and symbols are used to designate the same components as those of the first to third embodiments described above, and description thereof will not be given.

As shown in FIG. 7, in the cellular phone 10c of the fourth embodiment, a HDD 30 is disposed in a cover portion 12 that is openable/closable relative to an operation surface of a main body portion 11, with a PCB surface B facing a surface of the cover portion 12 opposite a surface where a main display 23 is disposed. In other words, the PCB surface B faces a rear surface of the cover portion 12 opposite a display surface.

The HDD 30 is disposed below a second area 38 (the position shown in the drawing) that is closer to a hinge portion 13 than the top edge of cover portion 12 and that does not include areas of a sub-display 28 and a camera portion 27 which are disposed on the rear surface of the cover portion 12.

As for the longitudinal/lateral placement direction of the HDD 30, it is contemplated that the longitudinal direction of the HDD 30 is set perpendicular to the longitudinal direction of the cover portion 12 as in the above-described embodiments.

The HDD 30 is disposed apart from the speaker 26 in the cover portion 12. Moreover, the HDD 30 of the cover portion 12 is disposed apart from the microphone 25 of the main body portion 11 not only in the open state but also in the state in the course of being closed. Therefore the structure of the forth embodiment, in which HDD 30 is disposed apart from the speaker 26 and the microphone 25, can realize an effective noise.

Such arrangement in which the HDD 30 is disposed below the area not including the sub-display 28 provided on the rear surface of the cover portion 12 can make the HDD 30 less susceptible to heat generated from the sub-display 28.

Further, since the HDD 30 and the main display 23 are adjacent to each other in the cover portion 12, the arrangement in which the PCB surface B faces the rear surface of the cover portion 12 enhances a heat release effect of the HDD 30 itself and makes the HDD 30 unsusceptible to heat from the main display 23.

Further, the HDD 30 is disposed in the area excluding the area of the sub-display 28, in particular, on a side closer to the hinge portion 13, so that the HDD 30 is not influenced by a magnet of a speaker 26. Moreover, since the position of the HDD 30 is close to the hinge portion 13, only a slight shock is given to the HDD 30 when the cover portion 12 is closed.

Incidentally, since an antenna is generally disposed on the main body portion 11 side in which a receiving circuit is provided, disposing the HDD 30 in the cover portion 12 side makes the HDD 30 unsusceptible to high-frequency noises and the like.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general invention concept as defined by the appended claims and their equivalents.

1. A portable information terminal, comprising:
a main body portion including a keypad and a microphone, the keypad being on a front surface of the main body portion;
a cover portion coupled to the main body portion, the cover portion adapted for placement in either (i) an open state where the keypad of the main body portion is accessible, or (ii) a close state in which the cover portion covers the keypad;
a magnetic disc device disposed in the main body portion; and
a sound insulating element disposed in the main body portion and insulating sound of the magnetic disc device from the microphone.

2. The portable information terminal according to claim 1, wherein the sound insulating element includes a sound insulating sheet disposed to at least partly cover the magnetic disc device in the main body portion.

3. The portable information terminal according to claim 1, wherein the sound insulating element includes a sound insulating sheet disposed to at least partly cover the microphone in the main body portion.

4. The portable information terminal according to claim 1, wherein the sound insulating element includes a sound insulating wall to separate a first space in which the magnetic disc device is placed from a second space in which the microphone is placed.

5. The portable information terminal according to claim 1, wherein the magnetic disc device is disposed between the keypad and the microphone in the main body portion.

6. The portable information terminal according to claim 1, wherein the, magnetic disc device is positioned under a finger rest area being an area of the main body portion between the keypad and the microphone.

7. The portable information terminal according to claim 1, further comprising:
a memory card slot disposed between the front surface and the magnetic disc device in the main body portion.

8. The portable information terminal according to claim 7, wherein the magnetic disc device is disposed in the main body portion below the memory card slot so that a heat generating board of the magnetic disc device faces a back surface of the main body portion being a surface opposite the front surface to the main body portion.

9. The portable information terminal according to claim 7, wherein the magnetic disc device and the memory card slot are disposed between the keypad and the microphone in the main body portion.

10. The portable information terminal according to claim 1, wherein the magnetic disc device includes a magnetic disc positioned within a housing mounted on a heat generating board, the heat generating board positioned between the front surface of the main body portion and the housing.

11. The portable information terminal according to claim 1, wherein the magnetic disc device includes a magnetic disc positioned within a housing mounted on a heat generating board, the housing positioned between the front surface of the main body portion and the heat generating board.

12. A portable information terminal, comprising:
a main body portion including a key operation portion and an audio input portion, the key operation portion situated on a front surface of the main body portion;
a cover portion coupled to the main body portion, the cover portion capable of being placed in an open state where the key operation portion is accessible and a close state where the cover portion faces the front surface and covers the key operation portion; and
a magnetic disc slot disposed in the main body portion and allowing a magnetic disc device to be removed.

13. The portable information terminal according to claim 12, wherein the magnetic disc slot is disposed between the key operation portion and the audio input portion in the main body portion.

14. The portable information terminal according to claim 12, further comprising a memory card slot is disposed between the front surface and the magnetic disc slot in the main body portion.

15. The portable information terminal according to claim 14, wherein the magnetic disc slot and the memory card slot are disposed between the key operation portion and the audio input portion in the main body portion.

16. The portable information terminal according to claim 12, wherein the magnetic disc slot allows the magnetic disc device to be removed without opening the main body portion; and

17. The portable information terminal according to claim 16, wherein the cover portion further includes a camera.

18. The portable information terminal according to claim 16, wherein the cover portion includes a display positioned to face a front surface of the main body portion with a key operation portion and an audio input portion when the cover portion is placed into a closed state.

19. A portable information terminal, comprising:
a main body portion having a key operation portion and an audio input portion, the key operation portion being positioned a front surface thereof;
a cover portion including a main display disposed on a first surface and a sub-display disposed on a second surface opposite to the first surface, the cover portion covering the key operation portion of the main body portion when the cover portion is placed in a close state, the main display facing the front surface of the main body portion when the cover portion is placed in the close state, the sub-display disposed in a first area of the second surface; and
a magnetic disc device disposed in the cover portion below an area of the second surface excluding the first area.

20. The portable information terminal according to claim 19, wherein the magnetic disc device includes a heat generating board and is disposed so that the heat generating board faces the second surface.
